(19) United States
(12) Patent Application Publication
(10) Pub. No.: US 2012/0023572 A1
(43) Pub. Date: Jan. 26, 2012

(54) Malicious Attack Response System and Associated Method

(75) Inventors: Timmy P. Williams, JR., Huntsville, AL (US); Hans Gregory Schantz, Hampton Cove, AL (US); Justin Richards, Huntsville, AL (US)

(73) Assignee: Q-Track Corporation, Huntsville, AL (US)

(21) Appl. No.: 12/843,002

(22) Filed: Jul. 23, 2010

(51) Int. Cl. G06F 21/06; G06F 21/00

(52) U.S. Cl. 726/13; 726/22; 726/11

(57) ABSTRACT

A system and method for detecting and identifying intruders in a computer network environment by providing a network traffic evaluation and simulation module at the interface between a protected network and external traffic source. The evaluation and simulation module identifies suspected intruders by observing intrusion pattern behavior and then presents a simulated network to the intruder. The simulated network appears to offer the intruder valuable information and provides the intruder with the appearance of success in breaking down the layers of the simulated network to keep the intruder engaged in the intrusion effort while information is gathered to trace and identify the source of the intrusion. Intrusion attempts are identified and categorized in an intrusion analysis module. The network traffic evaluation and simulated network may be provided as a self contained physical module that does not require modification of existing network software.

### FIELD OF THE INVENTION

The present invention pertains generally to the field of computer network security, more particularly to the detection and response to an attack from outside the network.

### BACKGROUND OF THE INVENTION

Wired and wireless networks by their nature are vulnerable to attacks from unwanted intruders. The military and civilian commercial world as well in that banking institutions, securities firms, and other numerous business interests are subject possible attack to gain information that could be used to extort the corporation or gain an unfair tactical advantage in the market place. Attacks may range from identity theft attempts, to corporate espionage, looking for financial information or technology, business plans, customer, supplier and other contact lists, etc. Other attacks may be aimed at damage, wiping a disk, overloading a system, denial of service, inserting a virus or Trojan.

Web security appliances mainly in the anti-virus field are being used to look for virus software signatures, and when found, either clean the virus from the traffic or delete the virus traffic all together. Many of the current firewalls and/or routers detect intrusion attempts, but because of the device design the devices typically drop the malicious traffic, when detected. As each new security device is employed, the attackers continue to devise more sophisticated attacks to defeat the new device. Thus, there is a continuing need for improved computer security.

### BRIEF DESCRIPTION OF THE INVENTION

The present invention relates to a system and method for detecting and identifying intruders in a computer network environment by providing a network traffic evaluation and simulation module at the interface between a protected network and external traffic source. The evaluation and simulation module identifies suspected intruders by observing intrusion pattern behavior and then presents a simulated network to the intruder. The simulated network appears to offer the intruder valuable information and provides the intruder with the appearance of success in breaking down the layers of the simulated network to keep the intruder engaged in the intrusion effort while information is gathered to trace and identify the source of the intrusion. Intrusion attempts are identified and categorized in an intrusion analysis module. The network traffic evaluation and simulated network may be provided as a self contained physical module that does not require modification of existing network software.

In one embodiment, the system threat assessment function operates on the network without having a source or destination location defined on said unprotected network as would have an Internet Protocol (IP) address assigned thereto.

In a further embodiment, the simulation module may simulate a firewall, a router, a bridge, a switch, a DMZ, a server, a user's computer or other component of a typical local area network (LAN).

In a further embodiment, the network simulation is configured to respond in accordance with the same IP address as the protected network.

In a further embodiment, the internet appliance computing device is configured to compare incoming traffic with a database of threat patterns and/or with a database of valid patterns to determine a threat status of said incoming traffic. The threat pattern database may include patterns related to IP addresses, MAC addresses, port knocking, scanning worm programs, or repeated failed passwords.

In a further embodiment, the system may include a monitor output capable of providing an alert when malicious traffic is detected. The monitor output may further provide packet data from said malicious traffic, including packet source IP (Internet Protocol) address.

In one embodiment the internet appliance computing device is housed as a single physical unit not requiring modification to the executable software in existing routers, firewalls, modems, or user's computers.

In a further embodiment, internet computing device further includes a modem or a firewall for said protected network.

Further embodiments include one or more of the following method steps:
1) receiving traffic for said local network from an unprotected network;
2) determining whether said traffic is valid traffic or malicious traffic;
3) sending said valid traffic to said local network;
4) sending said malicious traffic to a simulated network module and preventing said malicious traffic from being sent to said protected network;
   4a) said simulated network module providing a simulated response to said malicious traffic in accordance with a predefined network configuration; said predefined network configuration not revealing sensitive information from said protected network;
5) sending said simulated response to said unprotected network;
6) receiving a valid response from said local network;
7) sending said valid response to said unprotected network;
8) installing said system between said unprotected network and a first firewall of said protected system;
9) determining a change in assignment of said IP address for said protected network from said observing said valid traffic, and changing said IP address for said simulated network in accordance with the change in IP address for said protected network; or
10) changing at least one configuration variable in accordance with a progression in the attack.

These and further benefits and features of the present invention are herein described in detail with reference to exemplary embodiments in accordance with the invention.

### BRIEF DESCRIPTION OF THE FIGURES

The present invention is described with reference to the accompanying drawings. In the drawings, like reference numbers indicate identical or functionally similar elements. Additionally, the left-most digit(s) of a reference number identifies the drawing in which the reference number first appears.

FIG. 1A (prior art) is a functional flow diagram illustrating an exemplary trusted network connected to the Internet.

FIG. 1B illustrates the input of an exemplary network showing exemplary IP addresses.

FIG. 2 illustrates an exemplary network including a Malicious Attack Response System in accordance with the present invention.

FIG. 3 is a functional flow diagram illustrating an exemplary MARS in accordance with the present invention.

FIG. 4 is an exemplary functional flow diagram for a threat detection and assessment module in accordance with the present invention.

FIG. 5 is an exemplary functional flow diagram for a simulated network module process in accordance with the present invention.

### DETAILED DESCRIPTION OF THE INVENTION

The network traffic evaluation and simulated network may be referred to as a Malicious Attack Response System (MARS). The MARS is positioned between a protected network and an unprotected network that may contain intruders.

The M.A.R.S. System operates by instead of just detecting malicious attacks and dropping that network traffic MARS uses the Simulated Network Module to keep the attacker busy by allowing the attacker to think that they still have the possibility of gaining access to the target network. By allowing the attackers to think they are breaking down the network's defenses and starting to gain access, MARS keeps the attackers busy while the network administrator can be alerted and monitor the attackers efforts and possibly begin tracking down the attacker.

Once the M.A.R.S. device is deployed it will start collecting information on the connections that attempt to send data into the trusted local area network. The TDAM will log the information collected and build a database of all incoming traffic using current standards of detection and MARS own Artificial Neural Network that can be reviewed by the Network Administrators or operators. The TDAM will compare the information gathered in the database to the information that was input into the Configuration Information Page (CIP or White List) when the M.A.R.S. device was setup before deployment and use this information as one of the criteria needed to determine trusted network traffic from malicious attacks. The M.A.R.S. device uses a double assessment approach to identifying and characterizing data. The first approach is to detect any form of the most widely know methods of network information gathering some of these are Port Scanning, Port Knocking, Network finger Printing and the use of scanning worm programs. The second approach is the database the TDAM keeps and compares to the CIP this will allow all network traffic that has been pre-configured into the CIP to be passed into the trusted local area network.

### BACKGROUND

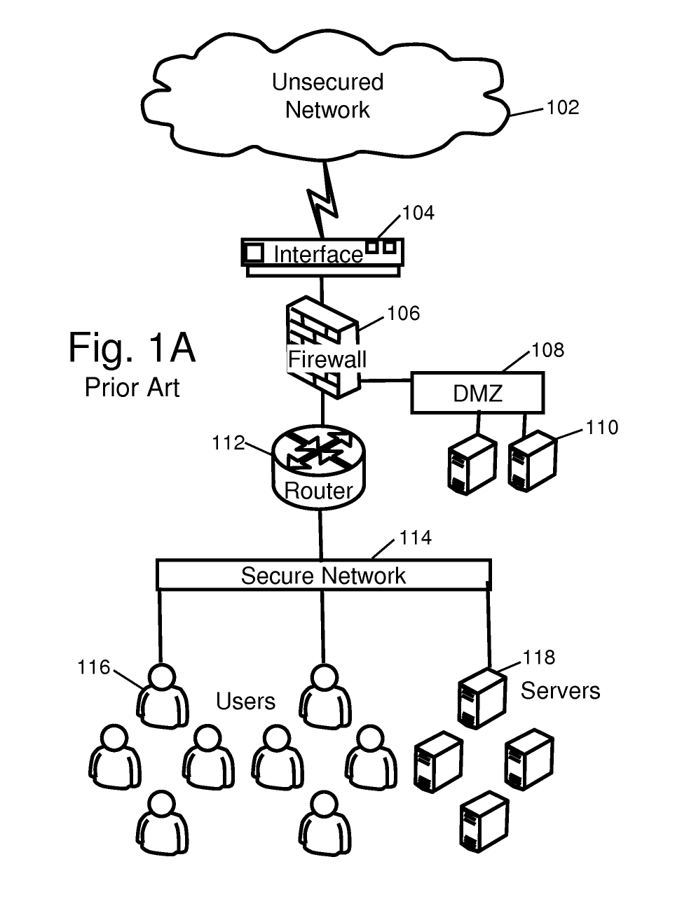

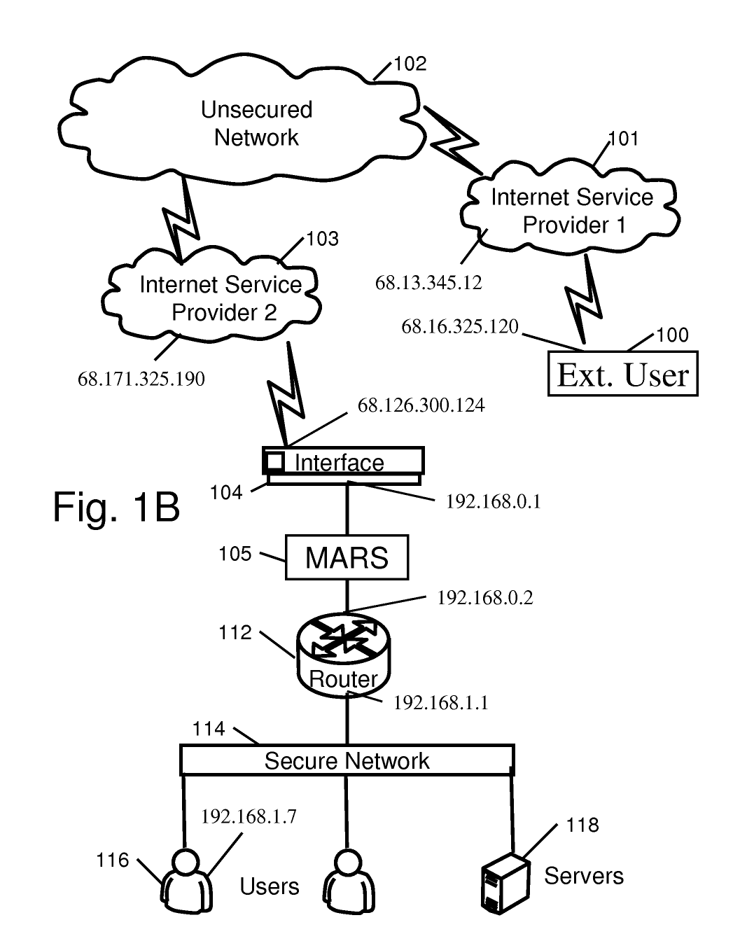

This section describes a typical target network utilized with the present invention. A typical network as might be used in a commercial setting connects a number of users to an external network, such as the Internet, that potentially contains hackers wishing to gain access to valuable private information or cause damage or other trouble for the users. As a consequence, these networks typically employ a number of techniques to limit access to only desired and authorized traffic. FIG. 1A, illustrates such a network.

FIG. 1A is a functional flow diagram illustrating an exemplary trusted network connected to the Internet. Referring to FIG. 1A, the Internet or other unsecured network is connected through a modem to the user's network. The modem may be wired or wireless and may be any speed from a telephone line modem to DSL, satellite, cable, optical fiber or other modem to connect to the external network. The modem provides a digital signal to the network. Some form of Ethernet is typically used, and other standards may alternatively be used. The modem may connect to a firewall. The firewall is the first line of defense against malicious intruders. Firewalls may operate at the network level, inspecting individual packets, or at the application level. Multiple firewalls may be employed. The firewall may be software only or may be a separate hardware unit. Larger systems typically install a separate hardware unit. A network level firewall typically utilizes one or more of the following techniques to block intruders:

port filtering,

source/destination Internet Protocol (IP) address checking against a white list and/or black list,

stateless or stateful packet inspection.

Packets that pass the firewall are sent to the router, which routes the packets to the destination user or server.

Some systems are configured to create a DMZ (De-Militarized Zone), also referred to as a perimeter network. The DMZ includes services such as web servers and some email servers and other services that do not house sensitive information. The DMZ may be configured between two firewalls or may be a designated output of a single firewall designed to support a DMZ. Servers in the DMZ have limited communication with the internal network, and thus if a DMZ server or service is compromised, sensitive data is not discovered, and the effects will not spread easily to the internal network.

The firewall typically has an external network side IP address used by the Internet to send packets to the system. The firewall includes a network address translation (NAT) function to forward packets to the internal network and shields the internal address information from the outside network.

Traffic (packets) that passes the firewall system is delivered to a router that routes packets to the destination user or server on the internal network. Router 112 is typically a subscriber edge router interfacing with the internet service providers edge router. Numerous alternative router types and network architectures may be supported. The router then feeds the protected network, which may be a local area network (LAN), which may include additional routers, bridges, switches, and wireless access points leading to the destination user.

FIG. 1B illustrates the handling of an exemplary packet from an external user to the protected network. Referring to FIG. 1B, FIG. 1B shows an external user 100 connected to an internet service provider 101 (ISP1). The ISP 101 communicates over the unsecure network 102 to the ISP2 103 of the protected network, which relays the communication to the protected network 104-114. The communication begins as one or more packets of information sent from the external user 100. Each packet may take a different route through the unsecure network 102, so each packet contains routing information including source and destination IP address as well as many of the intermediate IP addresses added in route. Each switch or router encountered may choose to add its IP address information or the next destination IP address to the packet In particular, the packets will contain at least one IP address identifying the external user 100 as a source. The packet will also likely contain one or more IP addresses internal to the ISP1 101 operations. The packet may also contain several IP addresses picked up from routing through the network and may include IP addresses from ISP2 103 indicating which servers and routers were used in the ISP2 103.

Exemplary IP addresses (IP version 4 addresses) are shown for the network. IPV4 addresses specify four bytes with a range of 0-255. The exemplary addresses in FIG. 1B purposely include one invalid out of range value to avoid coincidentally matching a real site. The addresses are strictly for illustration purposes. Referring to FIG. 1B, the modem address 68.126.300.124 is the address published to the world and associated with the web site URL (e.g. examplecompany123.com) the remaining addresses (192.168.x.x) are internal routing addresses not visible to the outside network and are used by the router 112 and other devices to send packets or to send control and configuration information directly to the device. Note that each network device normally has an input and output IP address.

A packet sent from external user 100 includes source IP address 68.16.325.120 and destination address 68.126.300.124. The packet passes through ISP1 and picks up one or more IP addresses, for example 68.13.345.12. The packet traverses the Internet and passes through ISP2, picking up IP address 68.171.325.190. The packet then goes through address translation to be routed to the final destination at user 192.168.1.7. Thus, the packet contains considerable routing information that can be used to trace back a packet to the source.

In addition to IP addresses, the packet will likely contain the source Media Access Control (MAC) address of the source network adapter in the originating computer, and may contain additional MAC address from additional devices in route. MAC addresses, by convention are unique to each device and can often be traced to the owner.

The MARS device 105, however, has no IP address and no MAC address. The MARS device sits on the network and passes traffic in both directions observing and acting on the traffic, but the MARS device has no IP address and generates no packets with a MARS return address and is thus not accessible through IP addressing on the network or from the Internet.

### Malicious Attack Response System

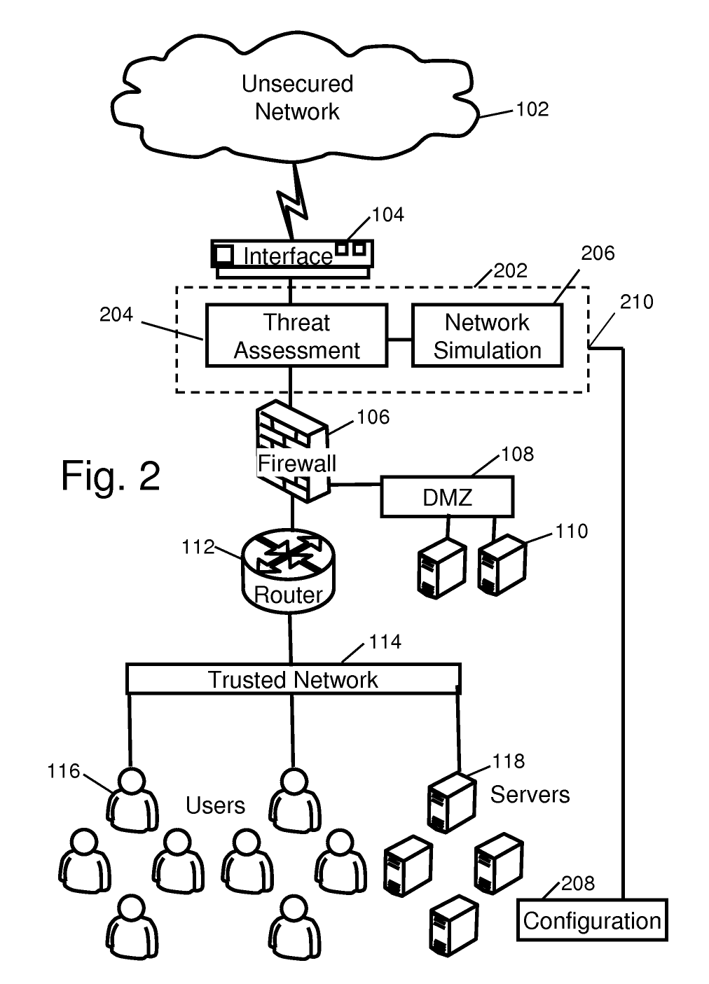

FIG. 2 illustrates an exemplary network including a Malicious Attack Response System in accordance with the present invention. Referring to FIG. 2, the Malicious Attack Response System 202, comprises a threat assessment function 204 and a network simulation function 206. The MARS 202 is typically placed at the input (or output) of the LAN between the modem 104 and first router 112 of the trusted network 114, preferably between the modem 104 and the first firewall 106 in systems having a firewall 106. In operation, the MARS receives incoming packets and determines whether the packets are likely to be malicious or valid traffic. Malicious packets, rather than being dropped or returned are delivered to a network simulation 206 designed to engage the attacker in activity that will at least delay the attacker and potentially discover information about the attacker. Malicious traffic is characterized and then classified according to the characterization. The simulated network offers various enticements to the attacker in the form of challenges, carrots, and apparent honey pots of valuable information that keep the attacker engaged, but delayed in progress. Network management is alerted to the attack in progress, may view the traffic in progress, and may work to trace back the traffic to the source. The trace back may identify further criteria for efficient threat identification and possibly assist law enforcement in the apprehension of attackers.

In one embodiment, the MARS network appliance 202 may be a single physical computer based unit installed by cabling between the interface 104 and the firewall 106. In alternative embodiments, the MARS functions may be built into or combined with, for example, a firewall 106 or router 112. In one alternative, the MARS may be placed behind the first router, as when the modem 104 includes a router, in which case, typically only one port of the modem/router is used. In a preferred embodiment, the MARS functions appear as a black hole in the network, i.e., there is no IP address associated with the threat assessment function. The lack of an IP address prevents malicious threats from “discovering” the MARS device and possibly affecting the MARS configuration.

All configuration of the MARS may be performed through a designated configuration interface 210 which may be a dedicated physical connector, which may be for example a communications port or USB interface or other dedicated interface. A central office may maintain a database of current threat patterns and may disseminate the threat patterns as needed. Provision may be made at the local network for periodic, on demand, or on alert updating of the threat assessment pattern database to be loaded into the MARS by the network administrator through the configuration interface 210. Newly discovered threat patterns, discovered by an individual MARS, may be downloaded from the MARS over the configuration interface 210 and communicated to the central office for analysis and possible dissemination to other MARS systems.

### DETAILED DESCRIPTION AND OPERATION OF THE PREFERRED EMBODIMENTS

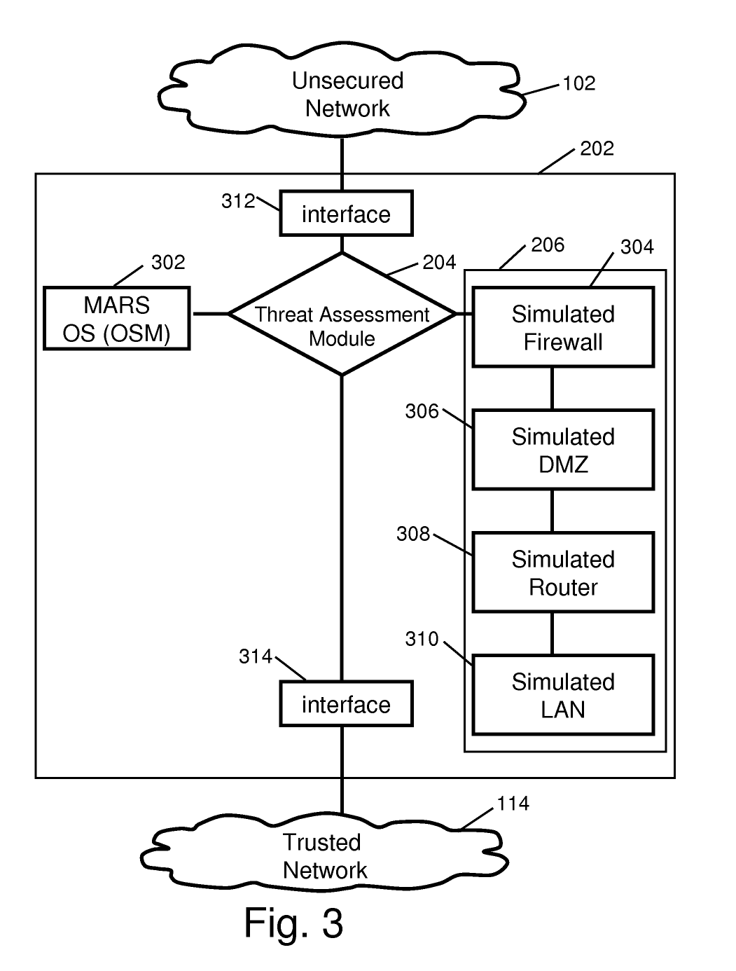

Further details of an exemplary MARS may be understood with reference to FIG. 3.

FIG. 3 is a functional flow diagram illustrating an exemplary MARS in accordance with the present invention. Note also that FIG. 3 represents a plural featured network simulation as may simulate a corporate LAN at a small business. Alternatively the SNM may simulate a system having a single home computer behind a telephone modem or any other typical network. Thus the simulated firewall, DMZ and router are each individually optional and the simulated LAN may serve one or more computers. Referring to FIG. 3, the MARS appliance 202 is shown as encompassing the functions enclosed in box 202 as an exemplary preferred embodiment; however, the functions may be distributed or merged or combined with other network devices as desired. The boundary defined by box 202 also depicts a desirable physical device that may be conveniently installed in typical existing deployed networks by simply plugging in and configuring the new device 202 without affecting the configuration or performance of the existing network and without requiring modifications to existing executable software in the existing routers, firewalls, modems, or user's computers. A network administration computer may run a monitor and configuration utility to configure and monitor operation of the device. In one embodiment, the configuration and/or monitor utility may self install using plug and play standards. Thus, installation can be simple, quick, and low risk.

The exemplary MARS appliance may include three functional blocks as shown, an operating system module (OSM 302), a threat assessment module (TASM) 204, and a simulated network module (SNM) 206. The TASM communicates with the unsecured network through a first interface 312 typically connected to the modem. The TASM communicates with the trusted network 114 through a second interface 314, typically connected to the firewall, if provided, or router, if no firewall is provided. The first and second interfaces are typically Ethernet based, but other alternative interfaces may be used.

In one embodiment, the MARS is a computer based network appliance that comprises two basic elements: a hardware element and a software element. The first element is the hardware element which may comprise a high performance computer. The high performance computer is desired to minimize any throughput delay that may cause latency in the external network connection. Good packets must be evaluated, determined to be good and passed through the system without causing excessive delay. The latency should preferably be held to less than a few tens of milliseconds. Suspected packets or packets determined to be from an intruder need not be passed so quickly.

The high performance computer may be a computer having a multicore processor, for example, a typical Dual DualCore or Dual QuadCore processor. The computer may include 4 Gb to 8 Gb of RAMM, two to three Ethernet interfaces and a hard drive large enough to hold the installed software element.

The second element is the software element which comprises three basic modules (See FIG. 3). In one embodiment, each software module may be threaded to a different respective core of the multicore computer. The three software modules may be contained inside one installable package.

The first software module is the Operating System Module (OSM) 302. The OSM may be any capable operating system. Linux based OS's are often used in network systems. In one embodiment, the OSM may comprise a trimmed down and hardened version of CentOS, a Linux based OS, to handle all of the duties required to run the computer.

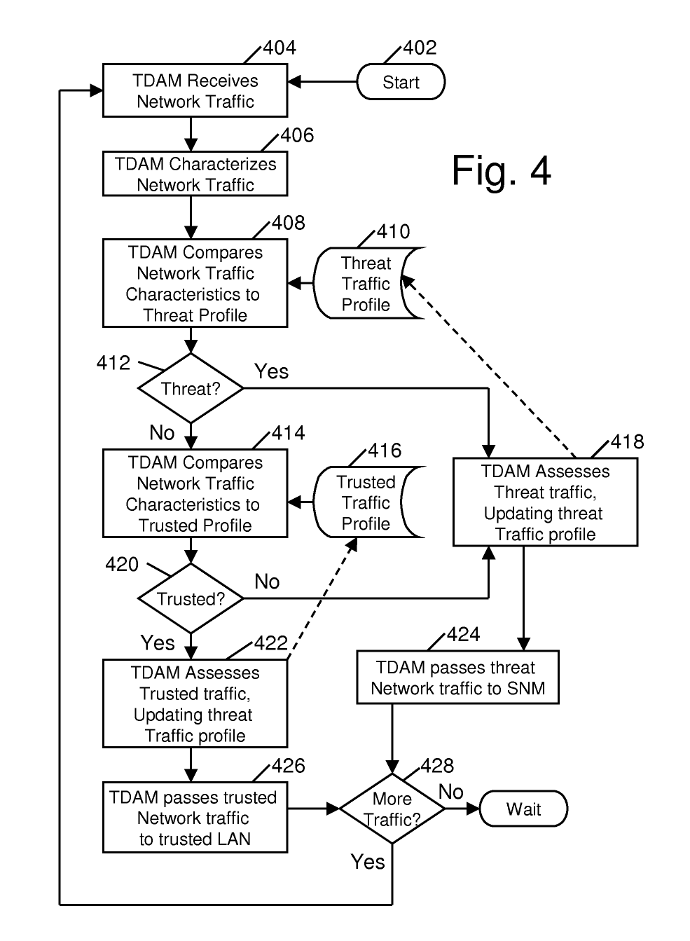

The second software module is the Threat Detection and Assessment Module (TDAM) 204. The TDAM main tasks is to monitor all incoming network traffic and to determine which traffic is trusted network traffic and which traffic is a malicious attempt to gain access to the network or capture network streamed data (See FIG. 4). The TDAM will pass the trusted network traffic to the second interface 314 coupled to the network's router to be routed to the internal destination. The malicious traffic will be internally routed to the third software module.

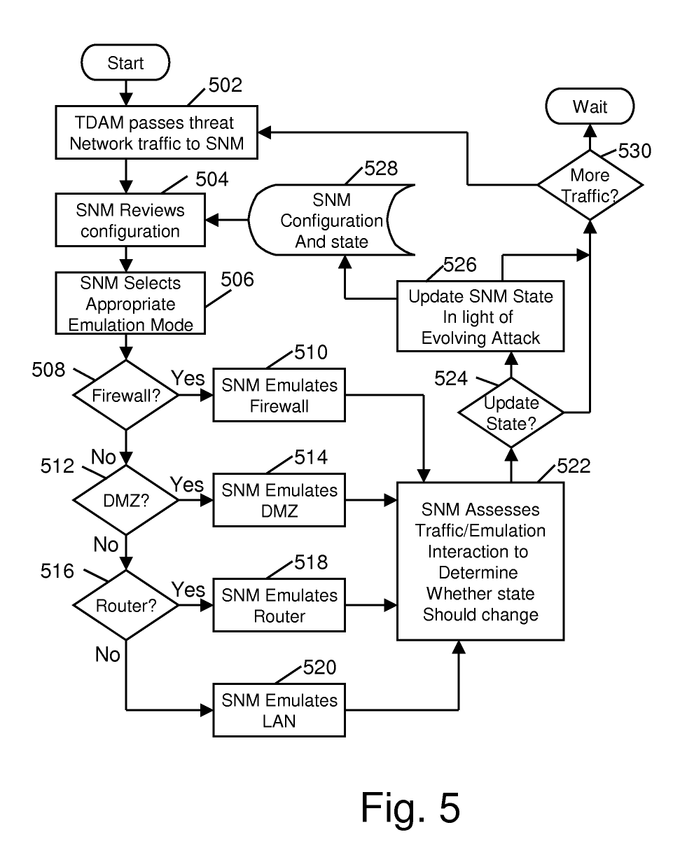

The third software module is the Simulated Network Module (SNM) 206. The SNM appears to the malicious traffic as the network stack that the malicious traffic was intended to infiltrate. The Simulated Network module may comprise three to four different blocks each of which will simulate a different part of a real world computer and information network. Each block of the simulated network can be customized to emulate any piece of network hardware (Firewall/Router, Router, Switch, Bridge or Local Area Network containing Users and/or Servers). See FIG. 5 for a block diagram of an exemplary software element.

The MARS appliance may also have a configuration administration interface 208. In one embodiment, the configuration interface 208 may be an HTML based interface which will allow the user/administrator to define the setup and configuration of the TDAM and SNM modules of the software. This configuration interface will allow the user to define detection modes and parameters, trusted network node and subnets and to add or remove data from the ‘Honey Pot’ database. The configuration interface is preferably connected using dedicated connector 210, which may be a USB port or other connection not shared on the network.

After the M.A.R.S. Appliance is configured and installed, the operation is completely automated. Configuration of the system can be fairly straight forward, comprising inputting various trusted Network information data into an HTML based configuration page (CIP or Configuration Information Page) in the software by a setup technician before the unit is deployed. Among the required setup data is the IP addresses required to communicate with the Wide Area Network and Local Area Network interfaces from the M.A.R.S. appliance. In one embodiment, the input to the SNM uses a copy of the IP address assigned to the real network router. This IP address may be input during configuration, or may be dynamically assigned by the internet service provider (ISP). Thus, in one embodiment, the MARS may evaluate packets from the ISP that may change the real system dynamic IP address and then change the simulated IP address accordingly.

During the configuration process, the elements to be simulated may be determined and the architecture of the simulated network may established, i.e., it may be desired to simulate a network with no firewall, no DMZ, and two computers on the LAN. Alternatively, the simulated network may include a typical firewall and may include a DMZ with one or more WEB servers, an email server, and an FTP server. The simulated network may be populated with any information that is already available to the public, such as the corporate web site including product descriptions, corporate leadership, investor information, and other information publicly available.

All network traffic incoming to the local area network will go through the M.A.R.S. network appliance. If the Threat Detection and Assessment module determines the traffic is safe the traffic is passed on to the network's router and passed on into the trusted network. If the traffic is deemed by the TDAM to be malicious in nature the traffic is internally passed by internal software routing to the Simulated Network Module (SNM)206. The traffic that is sent to the Simulated Network Module first hits the simulated firewall 304. There, the attacker find a way through the firewall revealing typical firewall break down operational patterns. Once through the firewall, the attacker may opt for typical DMZ 306 services looking for something of interest. The attacker may also go straight for the target network. At this point, the SNM appears to the attacker to be the front interface of the target network's router 308 where the attacker will continue the attack, but the attack will be able to be monitored and at that point can do no damage because the attack has been insolated. If the attack eventually reaches the last block 310 (Local Area Network Users/Servers) the attacker will be accessing data generated by an algorithm that will generate erroneous data based on the criteria setup during the systems configuration. Alternatively, M.A.R.S. can be configured to distribute data placed into a database at setup by the network operator for the purpose of giving false and misleading information to the attacker.

The TASM process will now be described in detail with reference to FIG. 4. FIG. 4 is an exemplary functional flow diagram for a threat detection and assessment module in accordance with the present invention. Referring to FIG. 4, the process begins with the reception of a network packet 404. The packet is buffered by the TDAM and characterized 406 to determine likelihood of the packet being a threat. The characterization data creates a packet profile that is compared 408 to threat traffic profile database 410. If a match occurs 412, threat traffic profile statistics and history are updated 418 and the threat traffic is diverted to the SNM 424. The system then waits 428 until more traffic is present and returns to receive the new traffic 404. Note that most traffic of interest is incoming traffic from the unprotected network; however, outgoing traffic may also be evaluated as many threat strategies begin with or include internal components.

Returning to step 408, if there is no match 412, i.e., no clear threat, the traffic is passed to step 414 where the characterization data profile is compared with trusted traffic profile database 416. The packet at this point may show some threat characteristics, but not a clear threat. If the characteristics match 420 a trusted profile, the trusted profile statistics are updated 422 and the packet is passed to the trusted LAN 426. If not 420, the pattern may be a new threat pattern and is passed to step 418, where statistics are updated and the threat profile may be updated to include the new threat. The traffic is then passed to the SNM for treatment as a threat 424.

In one embodiment, the threat pattern comparison result may be a likelihood value. The likelihood value may be combined with other ongoing threat assessment values and compared with a predefined threshold for a final determination of threat or no threat. For example, a packet may receive a threat likelihood of 30% from IP source information, while other activity, for example concurrent password failure activity, increases a threat status indicator to 30%. The combination being, for example a sum, is 60%—exceeding a predefined threshold of 50% and triggering a threat assessment for the packet. The predefined threshold may be adjusted through the configuration port to balance the false alarm rate in accordance with system objectives.

In one embodiment of the TDAM process, the comparison processes 408, 414 that compare the packet characterization profile with known threat profiles may be performed partially or entirely by an artificial intelligence neural network process. The neural network system is first trained by inputting known threat patterns and known valid patterns through the neural network during a training mode.

FIG. 5 is an exemplary functional flow diagram for a simulated network module process in accordance with the present invention. The diagram of FIG. 5 represents logic flow with respect to a single attack. Multiple attacks may be handled concurrently by time share or parallel processes like FIG. 5. Each attack may be identified by, for example, the source IP address of the packet. Thus, states and history may be recalled for each arriving packet based on the history of previous packets with the same source IP address. Note also that FIG. 5 represents a plural featured network simulation as may simulate a corporate LAN at a small business. Alternatively the SNM may simulate a system as a single home computer behind a telephone modem or any other typical network. Referring to FIG. 5, the SNM receives threat traffic from the TDAM 502. The SNM then establishes appropriate configuration 504 and emulation mode 506 for the threat packet. The modes may include, for example, firewall 510, DMZ 514, Router 518, or LAN 520. Each mode may support multiple sub modes and states, such as, DNS server, email server, or other service. Based on the emulation modes and states (branches 508, 512, and 514), the SNM emulates the appropriate layer (510, 514, 518, and 520) and function, sending response packets and modifying context states in response to the incoming packet 522. The packet response is completed by updating internal states in light of the evolving attack 524, 528, 526. The system then waits for additional traffic 530.

The evolving attack may comprise any detection of a threat activity. Such detection may raise the alert level for the same threat or related threats. The threat may evolve by action of the MARS system. MARS may allow an open port not actually used by the protected network. Traffic for the open port would likely be an active intruder and would be diverted to the SNM. Also, the SNM may present a password requirement, and may allow the intruder through after a password search attack to make the intruder believe it has found a valid password. Once “in” the intruder sees a honey pot with fake data. Thus, the attack evolves to a new state and presents the intruder with new information and new challenges.

In one embodiment, the simulated network may be adapted from existing software presently used to train IT professionals in network technology.

The SNM may also include a monitor function that may communicate with a computer in network administration (see FIG. 2, 208). The monitor output should preferably not be on the network. The monitor output may include an alert function to alert the operator of an attack in progress. The monitor may also include a display of packet details including packet size, type, port, source address, data content, and other identifiable details. Related packets and state of attack, such as simulated defense walls broken down and any attempts to install or run programs. For any attack ongoing and for all attacks over time statistics may be gathered including:

number of packets/messages over time,

type of attack,

passwords tried and failed,

passwords cracked,

ports scanned, scanned in a short time,

software installs attempted,

shell codes or other patterns found matching threat patterns,

files downloaded,

source IP address, IP addresses matching threat database.

### Attack Characterization

Attacks may be characterized in several modes. In one mode, each packet is examined for IP addresses, MAC addresses, shell codes, virus patterns and other patterns. I another mode, multiple packets are observed for patterns of behavior, such as port knocking or password attempting. In a third mode, multiple outgoing packets may be observed for patterns such as all being addressed to the same destination IP address, or through the same ISP or same country or area.

In the first mode, each packet is examined according to the threat database for a threat source IP address, MAC address or other address of a threat pattern. For example, a sophisticated threat may use multiple computers or multiple servers to generate the threat activity. These computers may likely use the same ISP or may originate from the same country or region where enforcement is lax. Thus, a threat may be detected by using more than just the source MAC or IP address, which can be spoofed or randomly generated. IP addresses generated in route are harder to spoof and can give valuable clues about a packet's potential threat. Also, a sophisticated threat may use temporary accounts on anonymous servers to launch an attack. These servers may also be detected by ISP, country or region of origin.

In the second mode, groups of packets may be evaluated for behavior patterns. For example, a port knocking attack attempts to find an open port for communications. There are 65536 ports available in port address space for communications. Ports are typically used for a particular function, for example port 80 is typically for WWW. HTTP service, port 110 is typically for POP3 email service. A firewall typically blocks requests to all but a few authorized ports. A port knocking attack will send a sequence of packets addressed to a number of different ports looking for any port that responds. The attack will then focus on that port—attempting to exploit whatever that port can offer. A port knocking attack may be detected by detecting a sequence of packets addressed to closed ports. The packets may have a common source IP address, or ISP or country as discussed previously. Upon finding a port knocking attack, the source IP addresses, MAC addresses are placed in the threat database. The port knocking attack may utilize a certain set of ports or a certain pattern order of port search, or a certain time delay between port knocks. All such data patterns are recorded for comparison with future suspected port knocking attacks, as future attacks from the same originator may use a different source IP and MAC. Any ISP and country information is also noted. A more sophisticated port knocking attack may come from several sources, each source with a different source ISP and MAC, but use the same set of ports or same sequence. The multiple source port knocks may also come through the same ISP or originate from the same country or come from a known set of servers, and thus be detectable as a threat. Thus, not only the source IP addresses, but the ISP and country or region information is entered in the threat database. The source country, region or ISP information, when it appears in the future may not necessarily flag a packet as a threat, but raises the level of suspicion for a packet so that together with other information, the packet may be declared a threat. For example, a port knock on a closed port from a suspicious region may establish a port knocking watch status. This followed in a few seconds by a port knock on an open port from the same region may flag the packet as a potential threat; whereas, by itself, the knock on the open port from a suspicious region may be allowed.

The threat database may also be updated by password failures or related entry protocol failures. An entry failure from a source IP/MAC that appears to be guessing passwords is also reason for entering the source IP/MAC and associated ISP, region etc in the threat database. Patterns of attempts, e.g., sequence, modifications of a root word, timing, and other patterns may be observed, compared with the threat database, recorded and entered in the threat database.

The threat database may include, but is not limited to:

Single packet information:

IP addresses, source, ISP, in route

MAC addresses, source

Shell codes and other malware patterns

Multiple packet pattern information:

Port knocking sequence patterns
Sets of ports attempted
Sequence of ports attempted

Port knocking timing patterns
Time between attempts
Total attempts tried in a given time interval

IP address, source, ISP, in route, country, region of port knocking sources

Password patterns

Time between attempts

Total attempts in time interval

IP address, source, ISP, in route, country, region of password attempt sources

The finding of any threat pattern may establish a threat watch mode for the related threat or for threats generally. The threat watch mode may increase the sensitivity for establishing a threat for a given packet as discussed previously.

### Valid Database

In one embodiment, the valid database is set up by the network administrator. The valid database may include allowed source IP/MAC addresses as well as valid source ISP, country information. In one embodiment the administrator may elect to reject any attempted entry not on the valid list. Alternatively, sources not on the valid database and not on the threat database may be allowed entry to certain portions of the network.

### Response To Attack

Multiple responses are possible and may be driven by details of the attack. Possible reasons for response may include, but are not limited to: 1) gather additional pattern data for threat database enhancement, 2) identify the attacker and initiate legal/administrative action, 3) ignore the attack to better focus resources elsewhere.

It may be that the IP address is a known threat from a country with no enforcement available. A possible action is to engage the threat to gather current pattern information. Alternatively the threat may be ignored. The threat may be from a country with enforcement available, in which case, the action may be to gather complete trace back information to identify the attacker to assist authorities in legal action against the attacker.

### Allowed Traffic

Not all attacks can be detected forever. Attackers will learn about new defenses and devise more sophisticated attacks. Thus the system, in one embodiment, may observe allowed traffic for unusual patterns. The successful attacker may engage in detectable suspicious activity. The attacker may look at unused or obsolete data sitting on a server or may have password trouble, or may attempt download of entire directories.

### CONCLUSION

In the game of cat and mouse between attackers and network designers and administrators, each new advance by network designers is learned and countered by attackers. Thus, the MARS may not always be too welcoming to the attacker to find the honey pot at the end of the simulated network, but may put up a fight to defend the honey pot. Once malicious traffic is detected by the TDAM instead of just indirectly routing the attack straight to the Simulated LAN the software may simulate current routers/firewalls and anti-intrusion software by dropping the malicious traffic thus causing the attacker to have to re-initiate the attack. This would cause the attacker to spend more time and resources in their effort to gain access to the network and allow the system more time to gather data on the attacker and trace back the attack.

Thus described is a system and method for a web tool allowing for flexible, interactive and adaptive attack detection, analysis, and defensive response.

One should understand that numerous variations may be made by one skilled in the art based on the teachings herein. The present invention has been described above with the aid of functional building blocks illustrating the performance of specified functions and relationships thereof. The boundaries of these functional building blocks have been arbitrarily defined herein for the convenience of the description. Alternate boundaries can be defined so long as the specified functions and relationships thereof are appropriately performed. Any such alternate boundaries are thus within the scope and spirit of the claimed invention. One skilled in the art will recognize that these functional building blocks can be implemented by discrete components, application specific integrated circuits, processors executing appropriate software and the like or any combination thereof.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

What is claimed is:

1. An internet appliance computing device for detecting malicious traffic and managing response to the malicious traffic to avoid damage from the malicious traffic, said device comprising:
a threat assessment module, said threat assessment module having a first interface for coupling to an unprotected network being potentially a source of malicious traffic, said threat assessment module having a second interface for coupling to a protected network; and
a simulated network module, said simulated network module coupled to said threat assessment module for receiving said malicious traffic and responding to said malicious traffic;
said simulated network module configured to respond in accordance with a predetermined network model not revealing private information of said protected network;
said threat assessment module configured for receiving network traffic from said unprotected network and assessing whether said network traffic is malicious traffic or valid traffic, said threat assessment module coupling said malicious traffic to said simulated network module and sending said valid traffic to said protected network;
said threat assessment module configured for receiving said response to said malicious traffic generated by said simulated network module and delivering said response to said malicious traffic to said source of malicious traffic through said unprotected network.

2. The internet appliance computing device of claim 1, wherein said threat assessment module has no traffic source or destination location defined on said unprotected network as would have an Internet Protocol (IP) address assigned thereto.

3. The internet appliance computing device of claim 1, wherein said simulated network module simulates a firewall.

4. The internet appliance computing device of claim 1, wherein said simulated network module is configured to respond in accordance with the same IP address as the protected network.

5. The internet appliance computing device of claim 1, wherein said simulated network module simulates a demilitarized zone.

6. The internet appliance computing device of claim 1, wherein said simulated network module simulates a local area network.

7. The internet appliance computing device of claim 1, wherein said internet appliance computing device is configured to compare said network traffic with a database of threat patterns to determine a threat status of said incoming traffic.

8. The internet appliance computing device of claim 1, wherein said internet appliance computing device is configured to compare said network traffic with a database of valid patterns to determine a threat status of said incoming traffic.

9. The internet appliance computing device of claim 1, further including a monitor output capable of providing an alert when said malicious traffic is detected.

10. The internet appliance computing device of claim 1, further including a monitor output capable of providing packet data from said malicious traffic, including packet source IP (Internet Protocol) address.

11. The internet appliance computing device of claim 1, wherein said internet appliance computing device is housed as a single physical unit not requiring modification to the executable software in existing routers, firewalls, modems, or user's computers.

12. The internet appliance computing device of claim 1, wherein said internet computing device further includes a modem or a firewall for said protected network.

13. The internet appliance computing device of claim 1, wherein said threat pattern includes patterns related to port knocking, scanning worm programs, or repeated failed passwords.

14. A method for protecting a local network comprising:
1) receiving network traffic for said local network from an unprotected network;
2) determining whether said network traffic is valid traffic or malicious traffic;
3) sending said valid traffic to said local network;
4) sending said malicious traffic to a simulated network module and preventing said malicious traffic from being sent to said protected network;
4a) said simulated network module providing a simulated response to said malicious traffic in accordance with a predefined network configuration; said predefined network configuration not revealing sensitive information from said protected network;
5) sending said simulated response to said unprotected network;
6) receiving a valid response from said local network; and
7) sending said valid response to said unprotected network.

15. The method in accordance with claim 14, wherein the steps 1-7 are performed by a network appliance device configured as a self contained physical unit installable without modification to existing modems, firewalls, routers, or user computers.

16. The method in accordance with claim 15, further including the step of installing said network appliance device between said unprotected network and a first firewall of said protected system.

17. The method in accordance with claim 14, wherein said predefined network configuration includes at least a router or a firewall.

18. The method in accordance with claim 14, wherein said predefined network configuration includes an element of a demilitarized zone.

19. The method in accordance with claim 14, wherein said simulated network module responds in accordance with an IP address assigned to said protected network.

20. The method in accordance with claim 14, further including the step of observing valid traffic for said protected network, determining a change in assignment of said IP address for said protected network from said observing said valid traffic, and changing said IP address for said simulated network module in accordance with the change in IP address for said protected network.

21. The method in accordance with claim 14, further including the step of:
changing at least one configuration variable in accordance with a progression in the attack.

22. The method in accordance with claim 14, further including a monitor observable in real time capable of displaying intruder packet information and simulated response state.

23. The method in accordance with claim 14, further including the step of comparing an incoming packet of said network traffic against a database of threat patterns to determine a threat status of said incoming packet; and
diverting said incoming packet to said simulated network if said incoming packet is determined to be a likely threat.

24. The method in accordance with claim 23, further including the step of comparing said incoming packet with a database of valid patterns to further determine the threat status of said incoming packet; and sending said incoming packet to said protected network if said incoming packet is determined to be a valid packet.

25. The method in accordance with claim 14, wherein said threat pattern includes port knocking, scanning worm programs or repeated failed passwords.
